(19) United States
(12) Patent Application Publication
(10) Pub. No.: US 2011/0002544 A1
(43) Pub. Date: Jan. 6, 2011

(54) IMAGE SYNTHESIZER AND IMAGE SYNTHESIZING METHOD

(75) Inventor: Hiroyuki OSHIMA, Kurokawa-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/827,638

(22) Filed: Jun. 30, 2010

(30) Foreign Application Priority Data
Jul. 1, 2009 (JP) 2009-156882

(51) Int. Cl. G06K 9/46

(52) U.S. Cl. 382/190

(57) ABSTRACT

Two camera assemblies in a multiple camera system output first and second images. In an image synthesizing method of stitching, an overlap area where the images are overlapped on one another is determined. Feature points are extracted from the overlap area in the first image. Relevant feature points are retrieved from the overlap area in the second image in correspondence with the feature points of the first image. Numbers of the feature points and the relevant feature points are reduced according to distribution or the number of the feature points. A geometric transformation parameter is determined according to coordinates of the feature points and the relevant feature points for mapping the relevant feature points with the feature points, to transform the second image according to the geometric transformation parameter. The second image after transformation is combined with the first image to locate the relevant feature points at the feature points.

### BACKGROUND OF THE INVENTION

1. Field of the Invention

The present invention relates to an image synthesizer and image synthesizing method. More particularly, the present invention relates to an image synthesizer and image synthesizing method in which image stitching of two images overlapped with one another can be carried out by synthesis with high precision even for any of various types of scenes.

2. Description Related to the Prior Art

Image stitching of synthesis of plural images overlapped with to one another is known, and is useful for creating a composite image of a wide field of view or with a very fine texture. An example of mapping positions of the plural images for synthesis is feature point matching. According to this, an overlap area where the plural images are overlapped on one another is determined by calculation. Feature points are extracted from edges of object portions in the overlap area. Differences between the images are detected according to relationships between the feature points in the images.

Precision in detecting differences between images is very important for precision in the image stitching. U.S. Pat. No. 6,215,914 (corresponding to JP-A 11-015951) discloses an idea for increasing precision in the detection of differences between images. A line picture is formed from one of two original images inclusive of lines of edges of an object in the image. A width of the line picture is enlarged, before feature points are extracted from the enlarged line picture. Also, U.S. Pat. No. 5,768,439 (corresponding to JP-A7-311841) discloses calculation of differences between images by manually associating feature points between plural images for image stitching by use of a computer. One of the images is moved by translation to compensate for the differences.

In FIGS. 9A and 9B, a first image 65 and a second image 66 are formed by photographing an object in a manner of overlap of their angle of view in a horizontal direction. Plural feature points 65c are extracted from the first image 65. Relevant feature points 66c in the second image 66 are determined in correspondence with respectively the feature points 65c. See the circular signs in the drawings. In each of the first and second images 65 and 66, objects are present, and include a principal object of one or more persons, and a background portion of a wall. It is easier to extract feature points in objects having appearance of complicated texture than in objects having appearance of uniform texture. The number of the feature points 65c extracted from the background portion is smaller than that of the feature points 65c extracted from the principal object. Uniformity of the distribution of the feature points 65c will be low.

If the first and second images 65 and 66 are combined for image stitching in FIG. 22, an obtained composite image 100 is likely to have a form locally optimized at its portion of the principal object, because the feature points are arranged in local concentration without uniform distribution. Precision in the image registration is low as a difference occurs at the background portion where the wall is present. Although U.S. Pat. Nos. 6,215,914 and 5,768,439 disclose improvement in the precision in detecting differences between the images, there is no suggestion for solving the problem of low uniformity in the distribution of feature points.

### SUMMARY OF THE INVENTION

In view of the foregoing problems, an object of the present invention is to provide an image synthesizer and image synthesizing method in which image stitching of two images overlapped with one another can be carried out by synthesis with high precision even for any of various types of scenes.

In order to achieve the above and other objects and advantages of this invention, an image synthesizer includes an overlap area detector for determining an overlap area where at least first and second images are overlapped on one another according to the first and second images. A feature point detector extracts feature points from the overlap area in the first image, and retrieves relevant feature points from the overlap area in the second image in correspondence with the feature points of the first image. A reducing device reduces a number of the feature points according to distribution or the number of the feature points. An image transforming device determines a geometric transformation parameter according to coordinates of uncancelled feature points of the feature points and the relevant feature points in correspondence therewith for mapping the relevant feature points with the feature points, to transform the second image according to the geometric transformation parameter. A registration processing device combines the second image after transformation with the first image to locate the relevant feature points at the feature points.

The reducing device segments the overlap area in the first image into plural partial areas, and cancels one or more of the feature points so as to set a particular count of the feature points in respectively the partial areas equal between the partial areas.

If the particular count of at least one of the partial areas is equal to or less than a threshold, the reducing device is inactive for reduction with respect to the at least one partial area.

The reducing device compares a minimum of the particular count between the partial areas with a predetermined lower limit, and a greater one of the minimum and the lower limit is defined as the threshold.

The position determining device further determines an optical flow between each of the feature points and one of the relevant feature points corresponding thereto. The reducing device determines an average of the optical flow of the feature points for each of the partial areas, and cancels one of the feature points with priority according to greatness of a difference of an optical flow thereof from the average.

The position determining device further determines an optical flow between each of the feature points and one of the relevant feature points corresponding thereto. The reducing device selects a reference feature point from the plural feature points for each of the partial areas, and cancels one of the feature points with priority according to nearness of an optical flow thereof to the optical flow of the reference feature point.

The reducing device selects a reference feature point from the plural feature points, cancels one or more of the feature points present within a predetermined distance from the reference feature point, and carries out selection of the reference feature point and cancellation based thereon repeatedly with respect to the overlap area.

Furthermore, a relative position detector determines a relative position between the first and second images by analysis thereof before the overlap area detector determines the overlap area.

The image synthesizer is used with a multiple camera system including first and second camera assemblies for photographing a field of view, respectively to output the first and second images.

The image synthesizer is incorporated in the multiple camera system.

The image synthesizer is connected with the multiple camera system for use.

Also, an image synthesizing method includes a step of determining an overlap area where at least first and second images are overlapped on one another. Feature points are extracted from the overlap area in the first image. Relevant feature points are retrieved from the overlap area in the second image in correspondence with the feature points of the first image. Numbers of the feature points and the relevant feature points are reduced according to distribution or the number of the feature points. A geometric transformation parameter is determined according to coordinates of the feature points and the relevant feature points for mapping the relevant feature points with the feature points, to transform the second image according to the geometric transformation parameter. The second image after transformation is combined with the first image to locate the relevant feature points at the feature points.

In the reducing step, the overlap area in the first image is segmented into plural partial areas, and one or more of the feature points are canceled so as to set a particular count of the feature points in respectively the partial areas equal between the partial areas.

If the particular count of at least one of the partial areas is equal to or less than a threshold, the reducing step is inactive for reduction with respect to the at least one partial area.

In the reducing step, a minimum of the particular count between the partial areas is compared with a predetermined lower limit, and a greater one of the minimum and the lower limit is defined as the threshold.

An optical flow is further determined between each of the feature points and one of the relevant feature points corresponding thereto. In the reducing step, an average of the optical flow of the feature points is determined for each of the partial areas, and one of the feature points is canceled with priority according to greatness of a difference of an optical flow thereof from the average.

An optical flow is further determined between each of the feature points and one of the relevant feature points corresponding thereto. In the reducing step, a reference feature point is selected from the plural feature points for each of the partial areas, and one of the feature points is canceled with priority according to nearness of an optical flow thereof to the optical flow of the reference feature point.

In the reducing step, a reference feature point is selected from the plural feature points, and one or more of the feature points present within a predetermined distance from the reference feature point is canceled, and selection of the reference feature point and cancellation based thereon are carried out repeatedly with respect to the overlap area.

Also, an image synthesizing computer-executable program includes an area determining program code for determining an overlap area where at least first and second images are overlapped on one another. An extracting program code is for extracting feature points from the overlap area in the first image. A retrieving program code is for retrieving relevant feature points from the overlap area in the second image in correspondence with the feature points of the first image. A reducing program code is for reducing numbers of the feature points and the relevant feature points according to distribution or the number of the feature points. A parameter determining program code is for determining a geometric transformation parameter according to coordinates of the feature points and the relevant feature points for mapping the relevant feature points with the feature points, to transform the second image according to the geometric transformation parameter. A combining program code is for combining the second image after transformation with the first image to locate the relevant feature points at the feature points.

Consequently, two images overlapped with one another can be synthesized with high precision even for any of various types of scenes, because the numbers of the feature points and the relevant feature points are reduced so as to maintain high precision locally in the image synthesis.

### BRIEF DESCRIPTION OF THE DRAWINGS

The above objects and advantages of the present invention will become more apparent from the following detailed description when read in connection with the accompanying drawings, in which:

FIG. 1 is a block diagram illustrating a multiple camera system as a digital still camera;

FIG. 2 is a block diagram illustrating a signal processor;

FIG. 3A is a plan illustrating a first image for image stitching;

FIG. 3B is a plan illustrating a second image for image stitching;

FIG. 4A is a plan illustrating the first image in the course of detecting feature points;

FIG. 4B is a plan illustrating the second image in which optical flows of the feature points are determined;

FIG. 5 is a plan illustrating an image after the feature point reduction;

FIG. 6A is a plan illustrating a first image for image stitching;

FIG. 6B is a plan illustrating a second image for image stitching;

FIG. 6C is a plan illustrating a composite image after geometric transformation;

FIG. 7 is a flow chart illustrating the image stitching;

FIG. 8A is a plan illustrating a first image for image stitching;

FIG. 8B is a plan illustrating a second image for image stitching;

FIG. 9A is a plan illustrating feature points extracted from the first image;

FIG. 9B is a plan illustrating relevant feature points extracted from the second image, and an optical flow between those;

FIGS. 10A and 10B are plans illustrating the feature point reduction in the embodiment;

FIG. 11 is a flow chart illustrating the feature point reduction;

FIG. 12 is a plan illustrating a composite image after the feature point reduction;

FIGS. 13A and 13B are plans illustrating the feature point reduction in one preferred embodiment;

FIG. 14 is a flow chart illustrating the feature point reduction;

FIGS. 15A and 15B are plans illustrating the feature point reduction in one preferred embodiment;

FIG. 16 is a flow chart illustrating the feature point reduction in the embodiment;

FIGS. 17A and 17B are plans illustrating feature point reduction in one preferred embodiment;

FIG. 18 is a flow chart illustrating the feature point reduction in the embodiment;

FIG. 19 is a block diagram illustrating an image synthesizer for image stitching of plural images;

FIG. 20 is a block diagram illustrating a signal processor;

FIG. 21 is a plan illustrating template matching of the images;

FIG. 22 is a plan illustrating a composite image formed without feature point reduction of the invention.

### DETAILED DESCRIPTION OF THE PREFERRED EMBODIMENT(S) OF THE PRESENT INVENTION

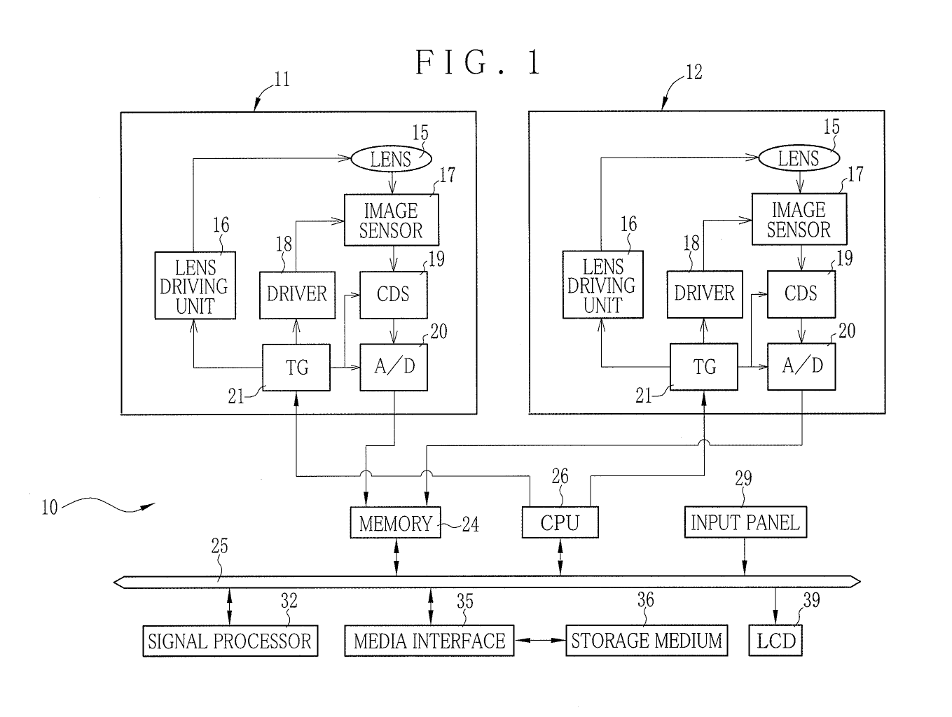

In FIG. 1, a multiple camera system 10 or digital still camera having an image synthesizer or composite image generator for image stitching of the invention is illustrated. Two camera assemblies 11 and 12 are arranged beside one another as an array, have fields of view which are overlapped on each other, and photograph an object. A composite image or stitched image with a wide area is formed by combining single images from the camera assemblies 11 and 12.

The camera assembly 11 includes a lens optical system 15, a lens driving unit 16, an image sensor 17, a driver 18, a correlated double sampling (CDS) device 19, an A/D converter 20, and a timing generator (TG) 21. The camera assembly 12 is constructed equally to the camera assembly 11. Its elements are designated with identical reference numerals of the camera assembly 11.

The lens optical system 15 is moved by the lens driving unit 16 in the optical axis direction, and focuses image light of an object image on a plane of the image sensor 17. The image sensor 17 is a CCD image sensor, is driven by the driver 18 and photographs the object image to output an image signal of an analog form. The CDS 19 removes electric noise by correlated double sampling of the image signal. The A/D converter 20 converts the image signal from the CDS 19 into a digital form of image data. The timing generator 21 sends a timing signal for control to the lens driving unit 16, the driver 18, the CDS 19 and the A/D converter 20.

An example of a memory 24 is SDRAM, and stores image data output by the A/D converter 20 of the camera assemblies 11 and 12. There is a data bus 25 in the multiple camera system 10. The memory 24 is connected to the data bus 25. A CPU 26 controls the camera assemblies 11 and 12 by use of the timing generator 21. The CPU 26 is also connected to the data bus 25, and controls any of circuit elements connected to the data bus 25.

An input panel 29 is used to input control signals for setting of operation modes, imaging, playback of images, and setting of conditions. The input panel 29 includes keys or buttons on the casing or outer wall of the multiple camera system 10, and switches for detecting a status of the keys or buttons. The control signals are generated by the switches, and input to the CPU 26 through the data bus 25.

A signal processor 32 combines two images from the camera assemblies 11 and 12 to form a composite image, and compresses or expands the composite image. A media interface 35 writes image data compressed by the signal processor 32 to a storage medium 36 such as a memory card. If a playback mode is set in the multiple camera system 10, the media interface 35 reads the image data from the storage medium 36 to the signal processor 32, which expands the image data. An LCD display panel 39 displays an image according to the expanded image data.

The display panel 39 is driven by an LCD driver. When the multiple camera system 10 is in the imaging mode, the display panel 39 displays live images output by the camera assemblies 11 and 12. When the multiple camera system 10 is in the playback mode, the display panel 39 displays an image of image data read from the storage medium 36.

To display a live image in the display panel 39, images from the camera assemblies 11 and 12 can be displayed simultaneously beside one another in split areas, or displayed selectively in a changeable manner by changeover operation. Also, the signal processor 32 can combine the images of the camera assemblies 11 and 12 to obtain a composite image which can be displayed on the display panel 39 as a live image.

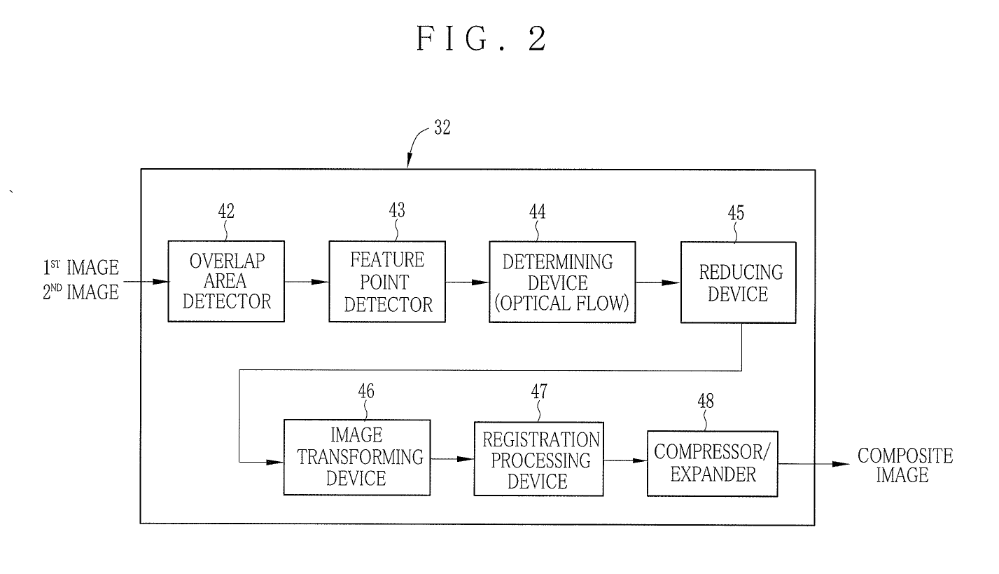

In FIG. 2, the signal processor 32 includes an overlap area detector 42, a feature point detector 43, a determining device 44 for an optical flow, a reducing device 45 or canceller or remover, an image transforming device 46, a registration processing device 47 or image synthesizing device, and a compressor/expander 48.

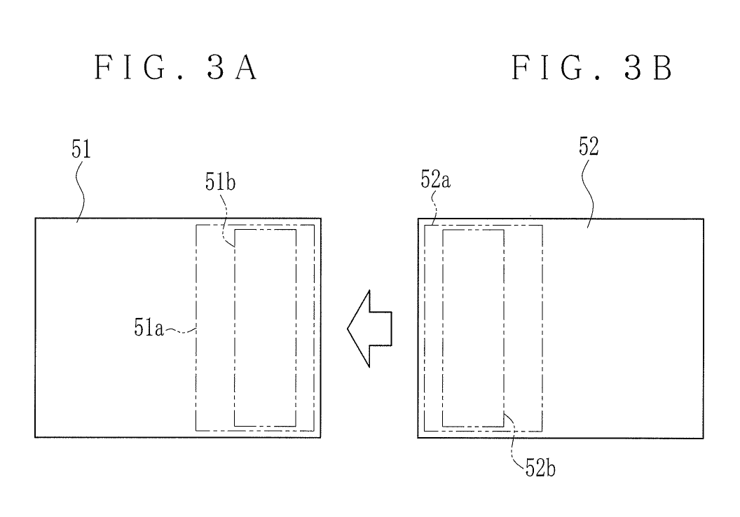

The overlap area detector 42 determines an overlap area where two images from the camera assemblies 11 and 12 are overlapped on one another. In FIGS. 3A and 3B, a first image 51 and a second image 52 are generated by the camera assemblies 11 and 12. The overlap area detector 42 analyzes an image area 51a of a right portion of the first image 51 according to template matching by use of a template area 52a of a left portion of the second image 52 as template information, so as to determine overlap areas 51b and 52b where a common object is present.

The template area 52a and the image area 51a for the template matching are predetermined with respect to their location and region according to an overlap value of the angle of view between the camera assemblies 11 and 12. For more higher precision in image registration, it is possible to segment the template area 52a more finely.

To determine the overlap areas 51b and 52b, a method of template matching is used, such as the SSD (sum of squared difference) for determining the squared difference of pixel values of the image area 51a and the template area 52a. Data RSSD of a sum of squared difference between the image area 51a and the template area 52a is expressed by Equation 1. In Equation 1, “Image1” is data of the image area 51a. “Temp” is data of the template area 52a. To determine the overlap areas 51b and 52b, it is possible to use the SAD (sum of absolute difference) or the like to obtain a total of the absolute value of the difference between pixel values of the image area 51a and the template area 52a.

$$RSSD ( a , b ) = {\sum }_{x = 0}^{TEMP \_ H} {\sum }_{y = 0}^{TEMP \_ W} {\vert \begin{matrix}Image 1 ( a + x , b + y ) - \\ Temp ( x , y )\end{matrix} \vert}^{2} \qquad [ Equation 1 ]$$

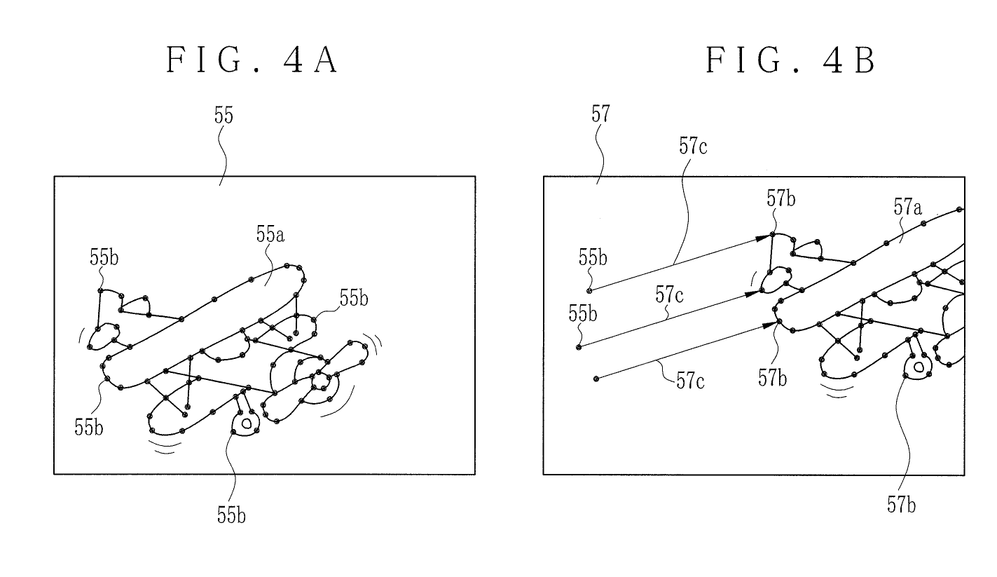

The feature point detector 43 extracts plural feature points with a specific gradient of a signal from the overlap area of the first image. In FIG. 4A, a first image 55 includes an area of an object image 55a. The feature point detector 43 extracts a plurality of feature points 55b from an edge of the object image 55a and its background portion. Examples of methods of extracting the feature points 55b includes a method of Harris operator, a method of Susan operator, and the like.

The feature point detector 43 tracks relevant feature points corresponding to feature points in the first image inside the overlap area in the second image output by the camera assembly 12. The determining device 44 arithmetically determines information of an optical flow between the feature points and the relevant feature points. The optical flow is information of a locus of the feature points between the images, and also a motion vector for representing a moving direction and moving amount of the feature points. An example of tracking the feature points is a KLT (Kanade Lucas Tomasi) tracker method.

In FIG. 4B, a second image 57 corresponding to the first image 55 of FIG. 4A is illustrated. An object image 57a is included in the second image 57, and is the same as the object image 55a of the first image 55. The feature point detector 43 tracks relevant feature points 57b within the second image 57 in correspondence with the feature points 55b of the first image 55. Information of an optical flow 57c between the feature points 55b and the relevant feature points 57b is determined by the determining device 44.

The reducing device 45 reduces the number of the feature points according to distribution and number of feature points, to increase uniformity of the distribution of the feature points in the entirety of the overlap areas. In FIG. 4A, a scene of the first image 55 is constituted by the object image 55a and a background portion such as the sky, it is unusual to extract the feature points 55b from the background portion because of its uniform texture of appearance of the sky. The distribution of the feature points 55b is not uniform as the feature points 55b are located at the object image 55a in a concentrated manner. When the second image 57 of FIG. 4B is combined with the first image 55, portions of the object images 55a and 57a are optimized only locally in the composite image. There occurs an error in mapping of the background portion.

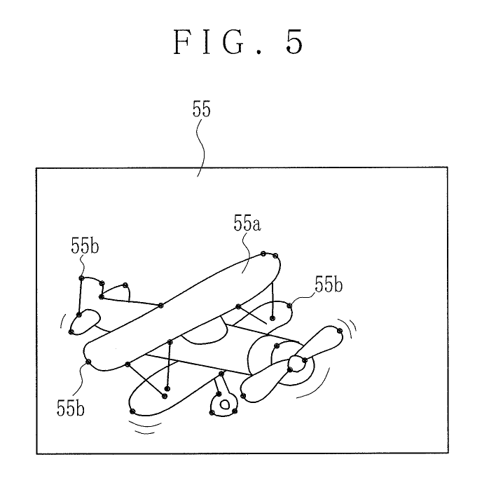

To keep high precision in the image registration in the optimization, the reducing device 45 decreases the feature points 55b of the first image 55 according to their number and distribution, to increase uniformity of the feature points 55b as illustrated in FIG. 5. The reducing device 45 also cancels the relevant feature points 57b of the second image 57 according to the feature points 55b canceled from the first image 55.

The image transforming device 46 determines geometric transformation parameters according to coordinates of the feature points and the relevant feature points for mapping the relevant feature points with the feature points, and transforms the second image according to the geometric transformation parameters. The registration processing device 47 combines the transformed second image with the first image by image registration, to form one composite image. The compressor/expander 48 compresses and expands image data of the composite image.

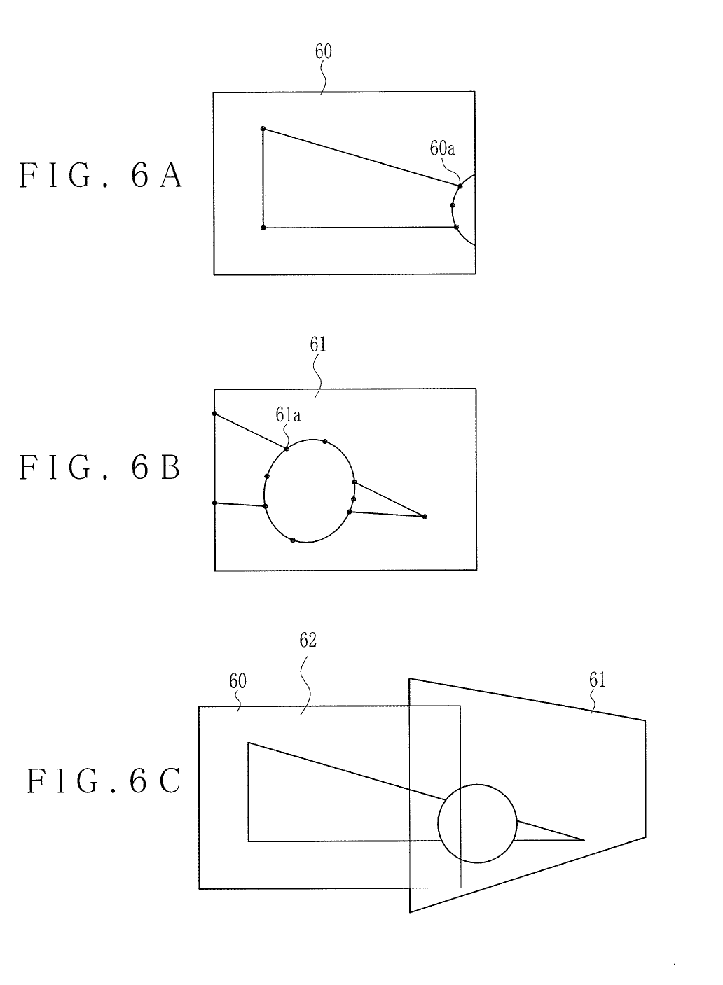

For example, the first and second images are images 60 and 61 of FIGS. 6A and 6B. Should the first and second images 60 and 61 be combined simply, no appropriate composite image can be formed. However, the second image 61 is transformed in the present invention to map a relevant feature point 61a of the second image 61 with a feature point 60a of the first image 60. See FIG. 6C. This is effective in forming a composite image 62 without creating an error between objects in the first and second images 60 and 61.

An example of geometric transformation to transform the second image 61 is an affine transformation. The image transforming device 46 determines parameters a, b, s, c, d and t in Equations 2 and 3 of the affine transformation according to coordinates of the feature point 60a and the relevant feature point 61a. To this end, the method of least squares with Equations 4-9 can be preferably used. Values of the parameters determined when the values of Equations 4-9 become zero are retrieved for use. After the parameters are determined, the second image 61 is transformed according to Equations 2 and 3. Note that a projective transformation may be used as geometric transformation.

$$\begin{matrix}{x}^{′} = ax + by + s & [ Equation 2 ] \\ {y}^{′} = cx + dy + t & [ Equation 3 ] \\ \frac{\partial {φ}_{x}}{\partial a} = 2 Σ ( {ax}^{2} + bxy + sx - {xx}^{′} ) & [ Equation 4 ] \\ \frac{\partial {φ}_{x}}{\partial b} = 2 Σ ( axy + {by}^{2} + sy - {x}^{′} y ) & [ Equation 5 ] \\ \frac{\partial {φ}_{x}}{\partial s} = 2 Σ ( ax + by + s - {x}^{′} ) & [ Equation 6 ] \\ \frac{\partial {φ}_{y}}{\partial c} = 2 Σ ( {cx}^{2} + dxy + tx - {xy}^{′} ) & [ Equation 7 ] \\ \frac{\partial {φ}_{y}}{\partial d} = 2 Σ ( cxy + {dy}^{2} + ty - {yy}^{′} ) & [ Equation 8 ] \\ \frac{\partial {φ}_{y}}{\partial t} = 2 Σ ( cx + dy + t - {y}^{′} ) & [ Equation 9 ]\end{matrix}$$

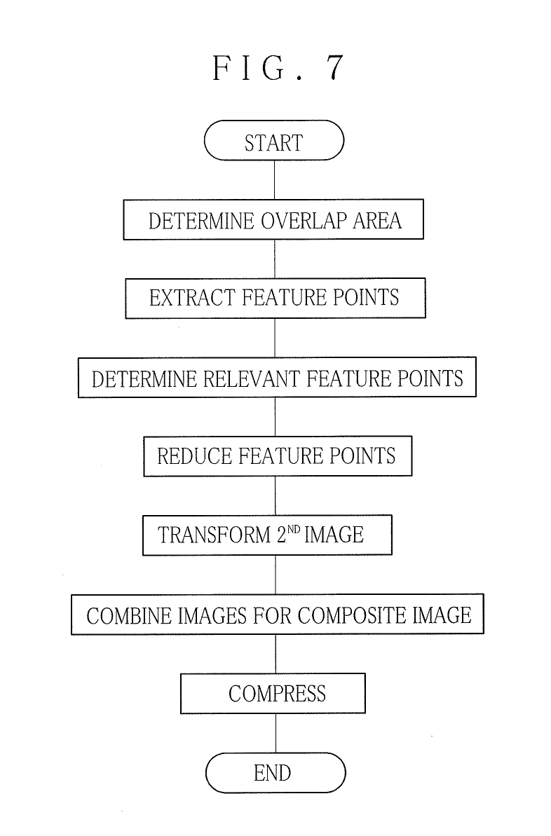

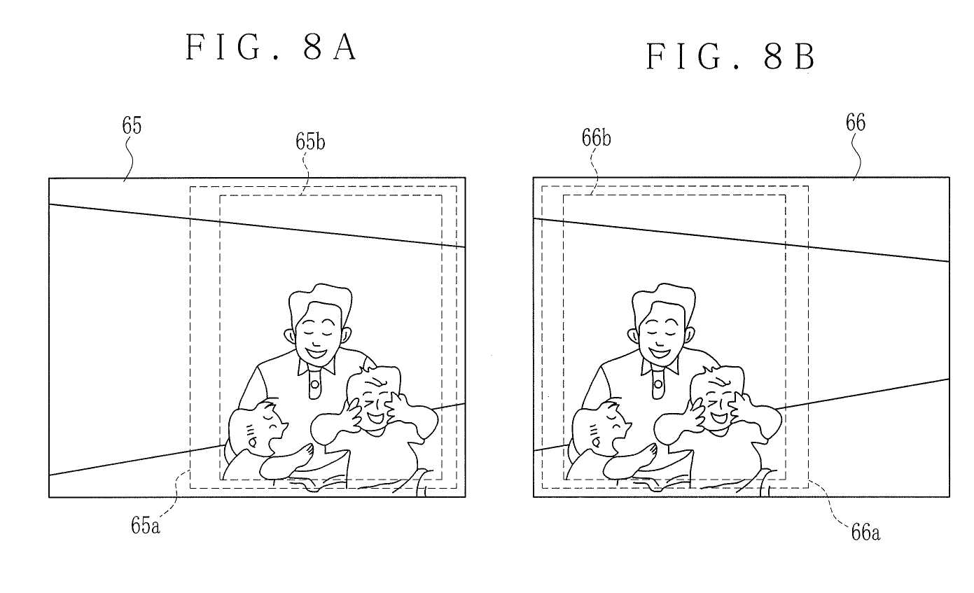

The operation of the signal processor 32 is described by referring to a flow chart of FIG. 7. The overlap area detector 42 reads image data generated by the camera assemblies 11 and 12 from the memory 24. In FIGS. 8A and 8B, a first image 65 and a second image 66 have forms according to the image data from the memory 24.

The overlap area detector 42 analyzes an image area 65a in the first image 65 by pattern matching according to the template information of a predetermined template area 66a of the second image 66. The overlap area detector 42 arithmetically determines overlap areas 65b and 66b in which the second image 66 overlaps on the first image 65. To determine the overlap areas 65b and 66b, Equation 1 is used.

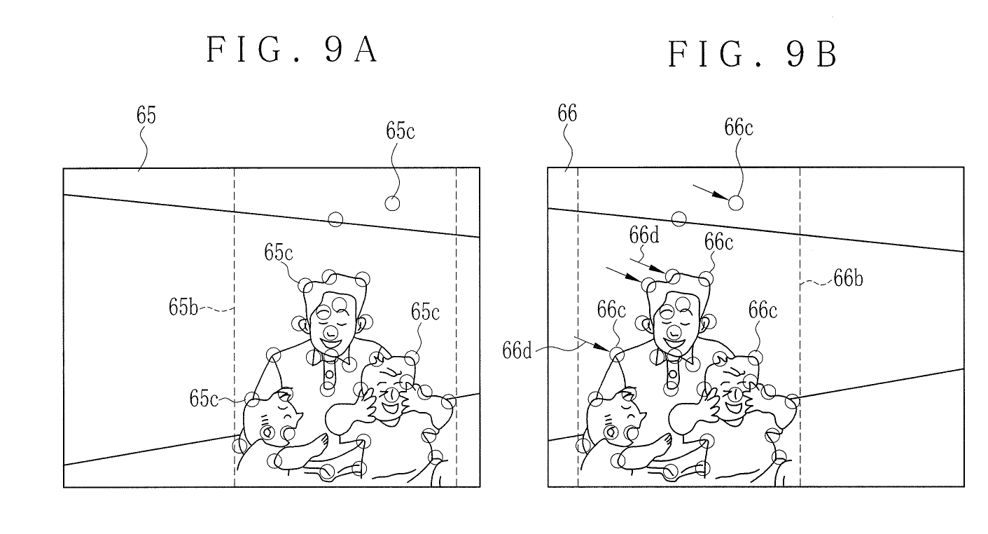

In FIG. 9A, the feature point detector 43 extracts plural feature points 65c from the overlap area 65b of the first image 65. Objects present in the overlap area 65b are a number of persons and a wall behind them. It is hardly possible to extract the feature points 65c from the wall due to the uniform texture of its surface. The feature points 65c are disposed at the persons in a concentrated manner.

In FIG. 9B, the feature point detector 43 tracks a plurality of relevant feature points 66c within the overlap area 66b of the second image 66 in correspondence with the feature points 65c of the first image 65. Also, the determining device 44 determines an optical flow 66d between the feature points 65c and the relevant feature points 66c. Note that the optical flow 66d for any one of the combinations of the feature points 65c and the relevant feature points 66c is determined although only the optical flow 66d is depicted partially for the purpose of clarity in the drawing.

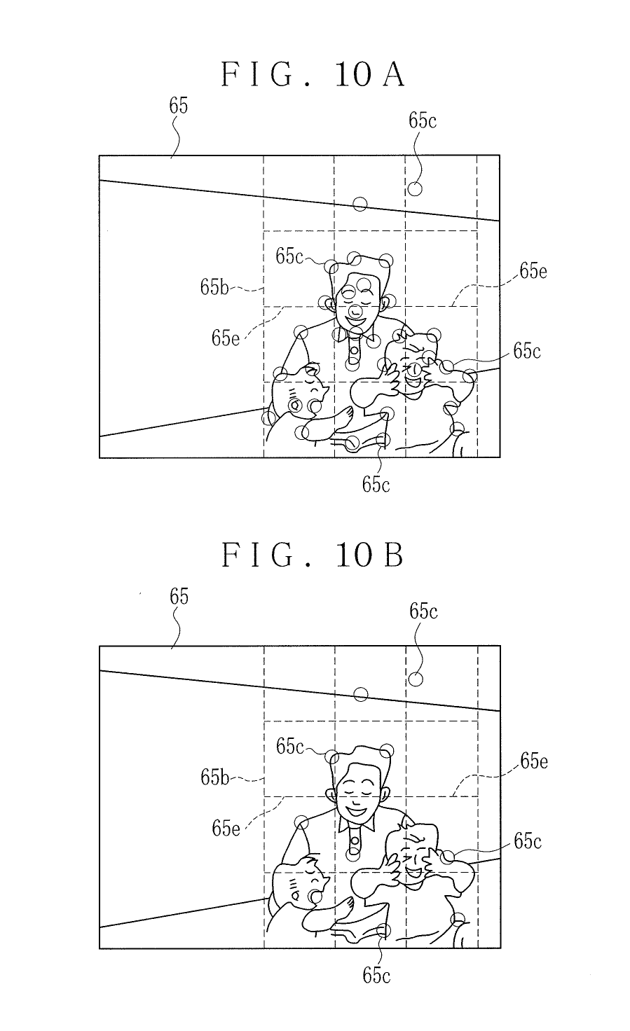

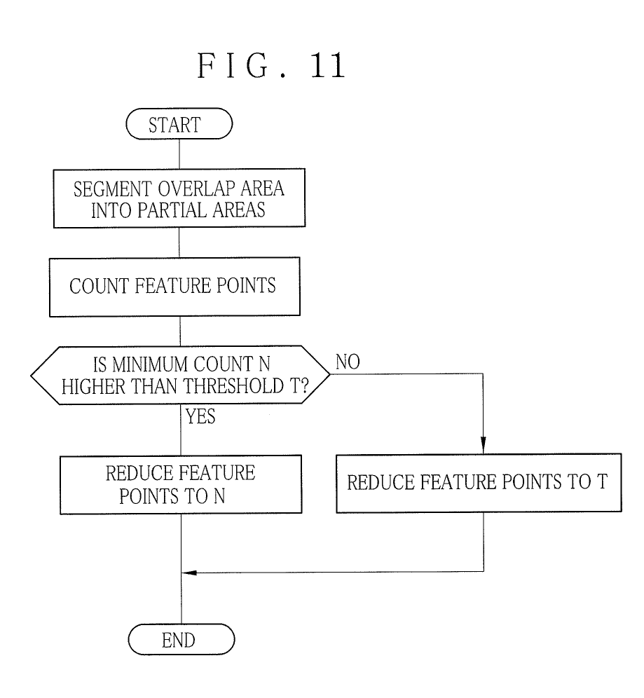

In FIGS. 10A and 11, partial areas 65e are illustrated. The reducing device 45 segments the overlap area 65b of the first image 65 into the partial areas 65e in a matrix form with m columns and n rows. A count of the feature points 65c within each of the partial areas 65e is generated. The minimum count N of the feature points among all the partial areas 65e is determined, and is compared with a threshold T predetermined suitably.

If the minimum count N of the feature points is greater than the threshold T, the reducing device 45 reduces the feature points 65c randomly until the count of the feature points 65c within each of the partial areas 65e becomes N. If the minimum count N is smaller than the threshold T, the reducing device 45 reduces the feature points 65c randomly until the count of the feature points 65c within each of the partial areas 65e becomes T.

In the example of FIG. 10A, there remains one or more of the partial areas 65e with no extraction of the feature points 65c. The minimum count N is zero (0). If the threshold T is one (1), the feature points 65c are randomly reduced within the partial areas 65e by the reducing device 45 until the count of the feature points 65c becomes one (1) for each of the partial areas 65e. See FIG. 10B. If the count of the feature points 65c in one partial area 65e is equal to or less than the threshold T, there is no reduction of the feature points 65c from the partial area 65e. The reducing device 45, after reducing the feature points 65c of the first image 65, reduces the relevant feature points 66c from the second image 66 in association with the feature points 65c.

Note that one or more of the feature points 65c to be canceled can be selected randomly, or suitably in a predetermined manner. For example, one of the feature points 65c near to the center coordinates of the partial areas 65e can be kept to remain while the remainder of the feature points 65c other than this are canceled.

The image transforming device 46 determines the parameters a, b, s, c, d and t of Equations 2 and 3 of the affine transformation according to the coordinates of the feature points 65c and the relevant feature points 66c according to the method of least squares of Equations 4-9. After the parameters are determined, the second image 66 is transformed according to Equations 2 and 3 of the affine transformation.

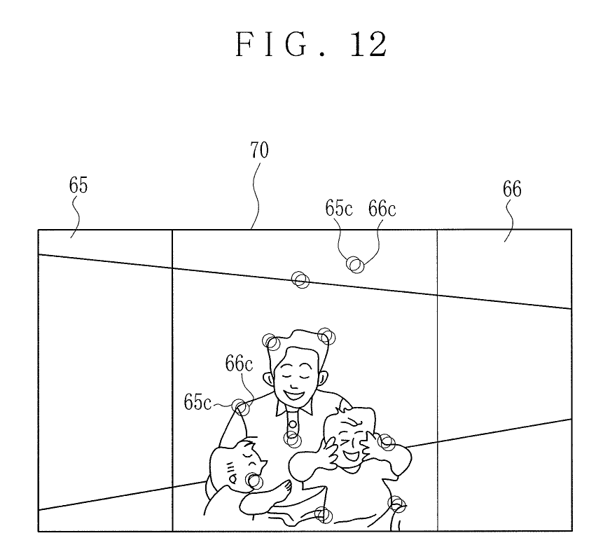

In FIG. 12, the registration processing device 47 forms one composite image 70 or stitched image by combining the first and second images 65 and 66 after the transformation according to the feature points 65c and the relevant feature points 66c. An example of a method of combining is to translate the second image 66 after transformation relative to the first image 65 by an amount equal to the average of the optical flows 66d of all the relevant feature points 66c within the overlap area 66b.

Redundant points among the feature points 65c and the relevant feature points 66c are canceled to synthesize the composite image 70 according to the remainder of the feature points 65c and the relevant feature points 66c for the uniform distribution. Thus, the composite image 70 can have a synthesized form with precision even at the background without errors due to local optimization. The compressor/expander 48 compresses and expands image data of the composite image 70. The image data after compression or expansion are transmitted through the data bus 25 to the media interface 35, which writes the image data to the storage medium 36.

A second preferred embodiment of the reduction by cancellation is described now. Element similar to those of the above embodiment are designated with identical reference numerals. Although the feature points 65c are reduced randomly in the first embodiment, a problem may arise in insufficient uniformity of the feature points 65c because some of the feature points 65c very near to each other may remain in adjacent areas even after the reduction by cancellation. In view of this, reduction of the feature points 65c is carried out according to an optical flow in each of the partial areas 65e.

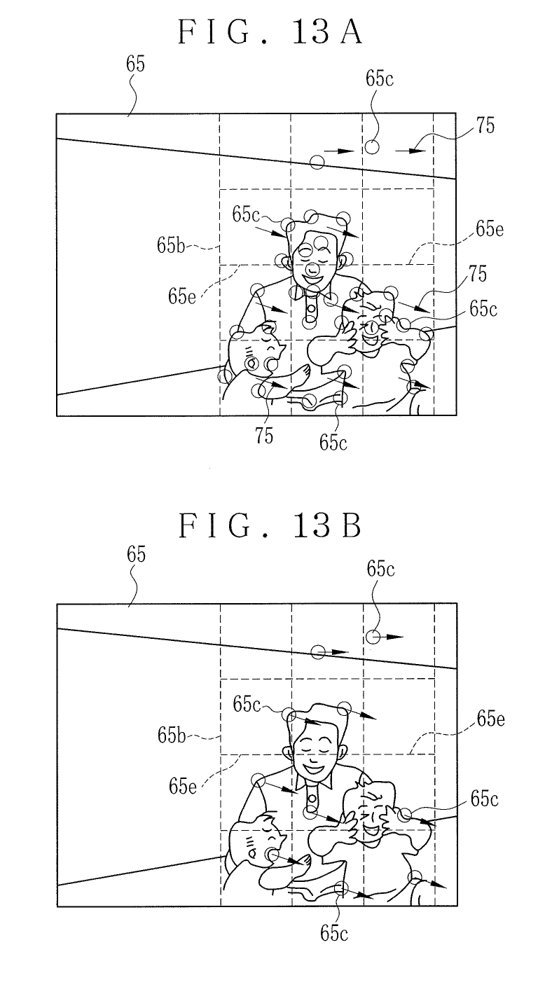

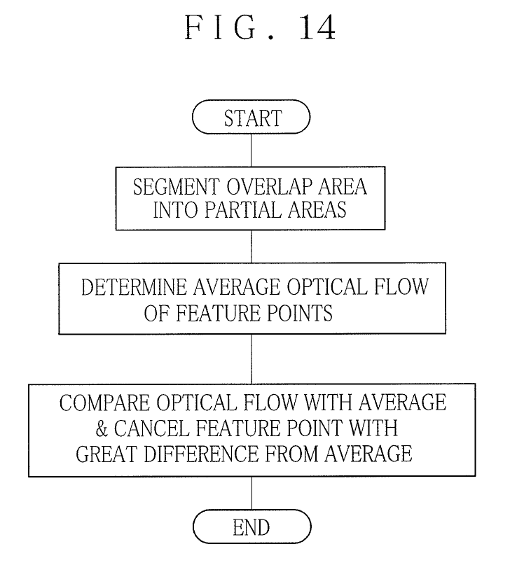

In FIGS. 13A and 14, the reducing device of the second embodiment determines an average optical flow 75 of the feature points 65c for each of the partial areas 65e. In the drawing, the average optical flow 75 is illustrated. Then the reducing device compares an optical flow of the feature points 65c with the average optical flow 75 for each of the partial areas 65e. N of the feature points 65c with an optical flow near to the average optical flow 75 are kept uncancelled for each of the partial areas 65e. The remainder of the feature points 65c are canceled. If the count N is one, the remainder of the feature points 65c in the overlap area 65b of the first image 65 is disposed in the distribution of FIG. 13B. It is thus possible to increase uniformity of the distribution of the feature points 65c more highly than in the partial areas 65e of the first embodiment.

A third preferred embodiment of the reduction by cancellation is described now. Element similar to those of the above embodiments are designated with identical reference numerals. Should one of the feature points 65c have an optical flow with a specific difference from the average optical flow in the overlap area 65b in the second embodiment, a problem may arise in an error in the image registration in the vicinity of the feature point 65c with the specific optical flow. In view of this, reduction of the feature points 65c is carried out only to keep at least one of the feature points 65c with a specific optical flow.

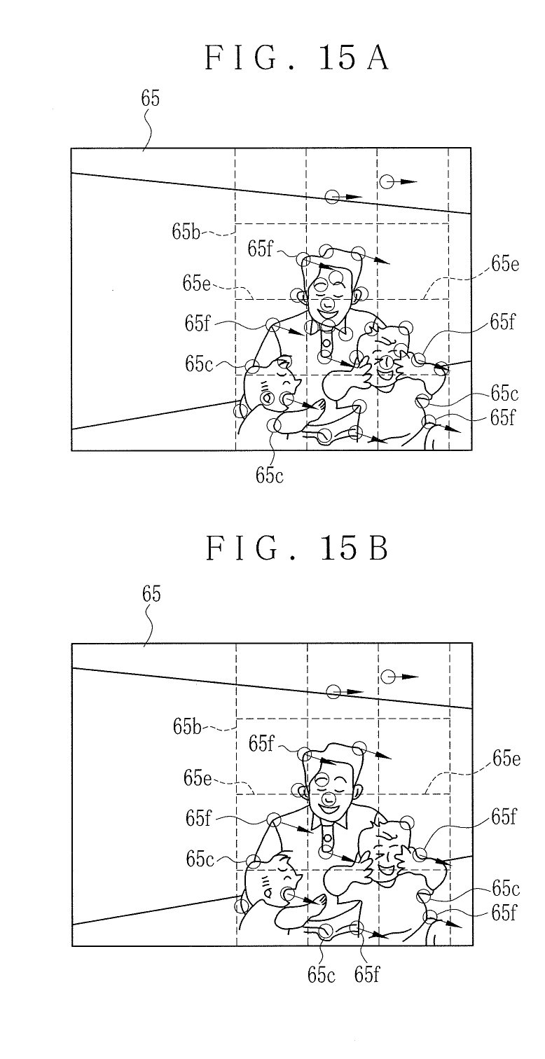

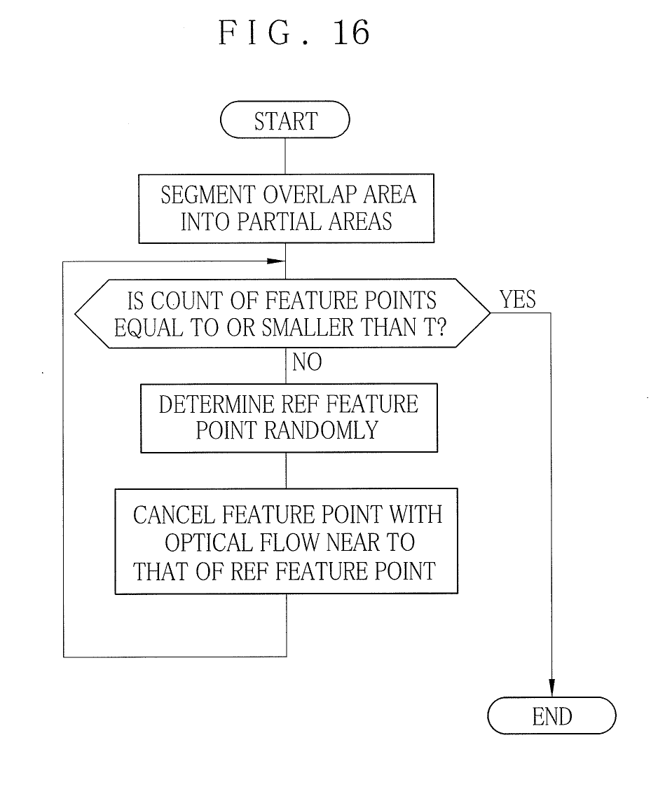

In FIGS. 15A and 16, a reducing device of the third preferred embodiment determines a reference feature point 65f randomly for each of the partial areas 65e. In FIG. 15A, a feature point with the arrow of the optical flow is the reference feature point 65f. The feature points 65c without the arrow are canceled. The reducing device cancels the feature points 65c in a sequence according to nearness of their optical flows to that of the reference feature point 65f. T of the feature points 65c are kept uncancelled in each of the partial areas 65e, where T is a predetermined number.

For example, if the value T is two (2), two feature points are caused to remain in the overlap area 65b as illustrated in FIG. 15B, including the reference feature point 65f and one of the feature points 65c having the optical flow with a great difference from that of the reference feature point 65f. Thus, precision in the image registration can become high, because the feature points 65c without near optical flow are used for the image registration.

A fourth preferred embodiment of reduction by cancellation is described now. Elements similar to those of the above embodiments are designated with identical reference numerals. In the above embodiments, the overlap area 65b are segmented into the partial areas 65e to adjust the count of the feature points 65c for each of the partial areas 65e. However, a problem remains in insufficient uniformity of distribution of the feature points 65c due to partial failure of reduction of the feature points 65c within two adjacent areas of the partial areas 65e. In view of this, the fourth embodiment provides further increase in the uniformity of the feature points 65c.

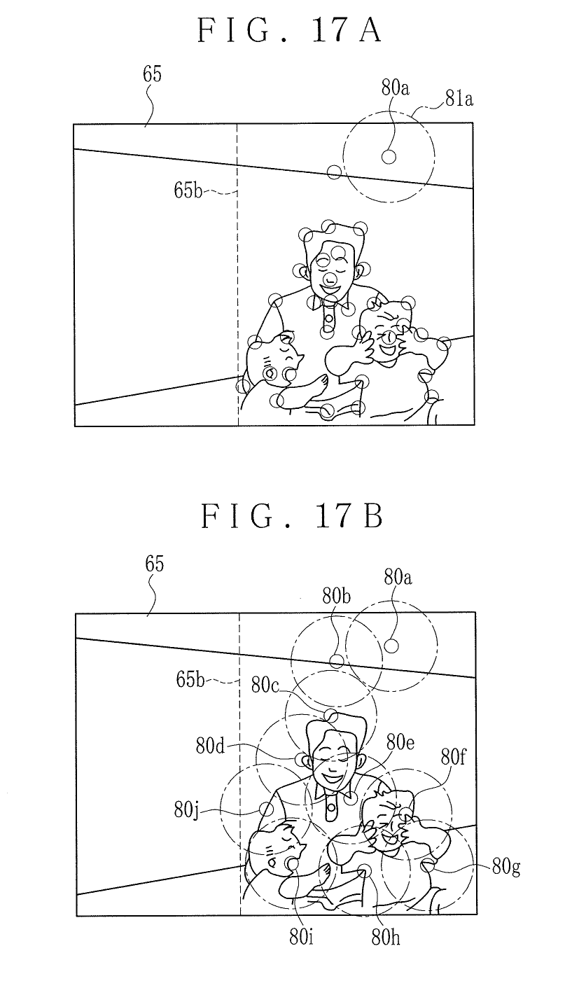

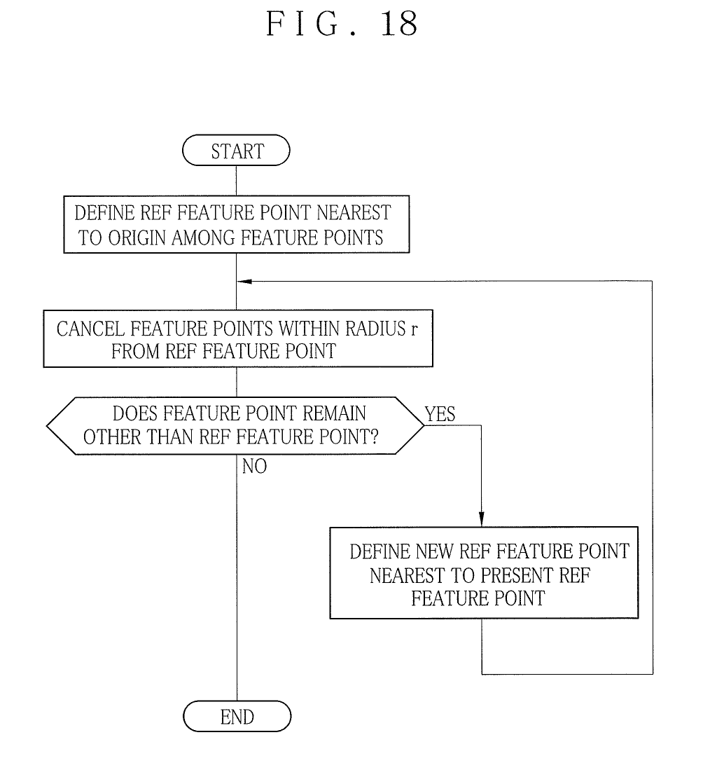

In FIGS. 17A and 18 for the embodiment, one of the feature points having a shortest distance from an origin of the first image 65 is retrieved as an initial reference feature point. The origin may be a predetermined position in the first image 65, or may be a predetermined position in the overlap area 65b. In the embodiment, the origin is determined at a point of the upper right corner of the first image 65. Thus, a first feature point 80a is selected first. The reducing device cancels all feature points within a virtual circle 81a which is defined about the first feature point 80a with a radius r. Should there be no feature point to be canceled or should all feature points be canceled, the reducing device designates a second reference feature point by designating one of remaining feature points the nearest to the presently selected reference feature point. Then the reducing device cancels all feature points within a predetermined distance r from the second reference feature point. This reducing sequence is repeated by the reducing device until all feature points other than the reference feature points are canceled.

In FIG. 17B, the first image 65 is illustrated after reduction of feature points according to reference feature points inclusive of the first feature point 80a and a final feature point 80j. Thus, the feature points are arranged in distribution with intervals equal to or more than a predetermined distance. Precision of the image registration can be high.

Note that three or more images may be combined for one composite image in the invention. For example, three or more camera assemblies may be incorporated in the multiple camera system 10. Images output by the camera assemblies maybe combined. To this end, a composite image may be formed by successively combining two of the images. Otherwise, a composite image may be formed at one time by using an overlap area commonly present in the three or more images.

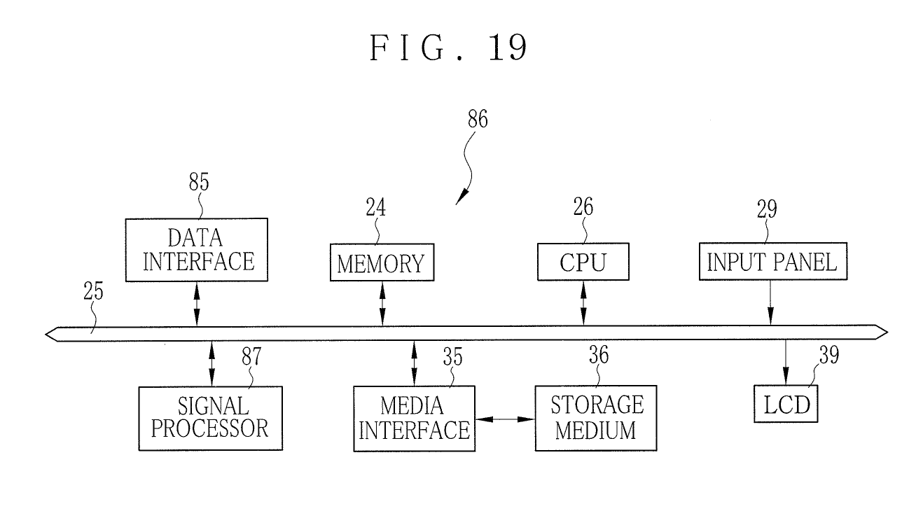

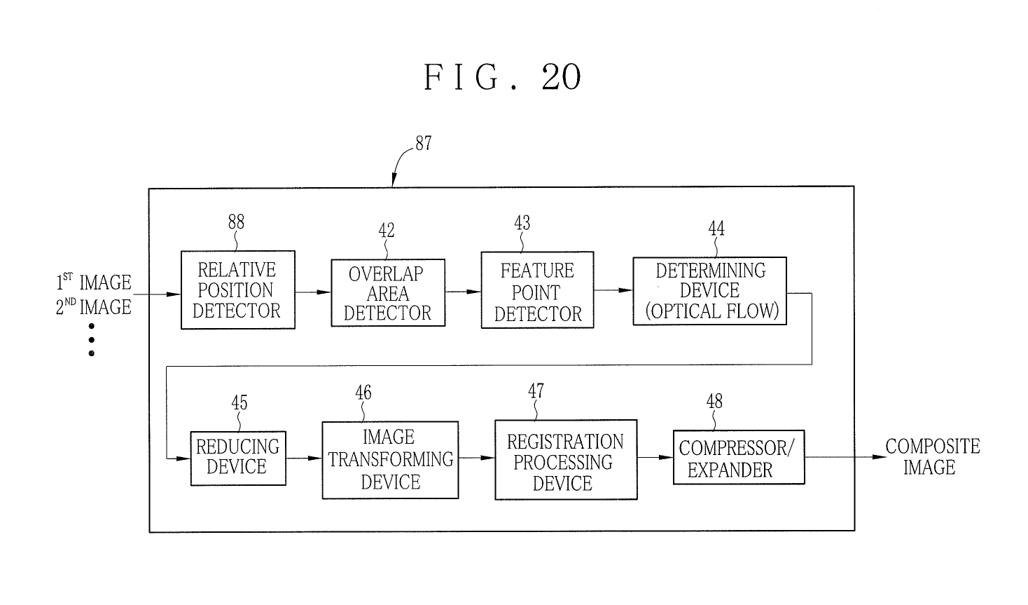

In the above embodiments, the image synthesizer is incorporated in the multiple camera system 10. In FIG. 19, another image synthesizer 86 or composite image generator of a separate type for image stitching is illustrated. A data interface 85 is caused to input plural images to the image synthesizer 86. In FIG. 20, the image synthesizer 86 has a signal processor 87. A relative position detector 88 is preferably associated with the signal processor 87 for determining relative positions between images by image analysis of the plural images.

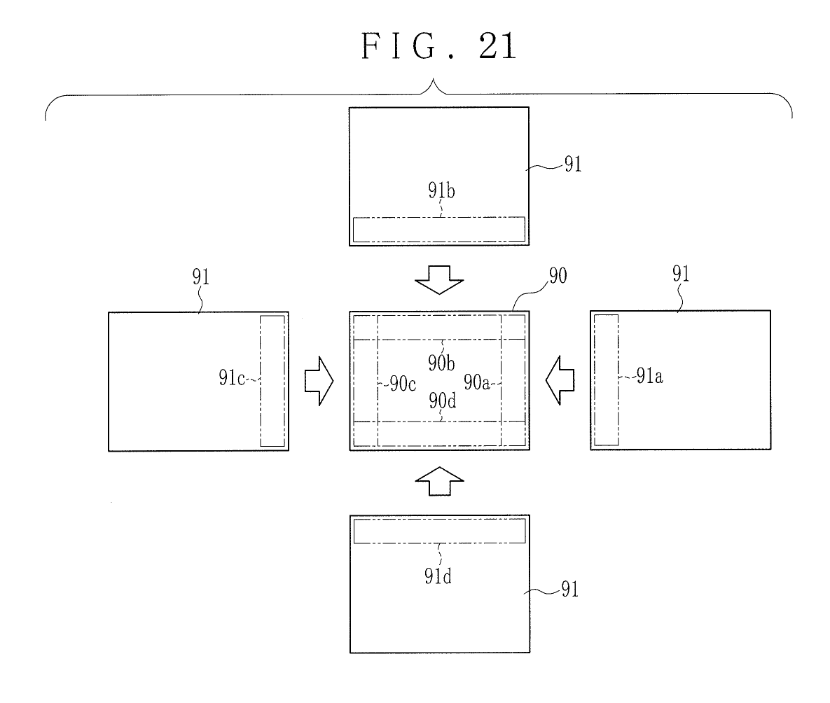

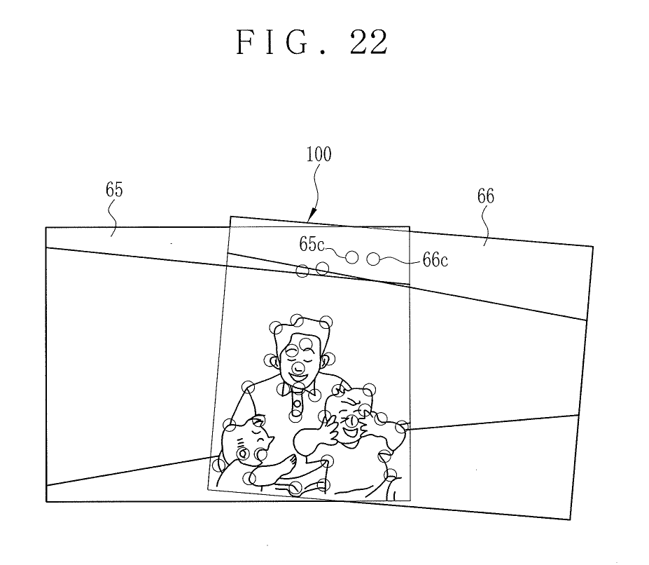

It is preferable in the relative position detector 88 and the overlap area detector 42 to determine an area for use in template matching according to relative positions of plural input images. In FIG. 21, a second image 91 or target image for combining with a first image 90 or reference image is disposed to the right of the first image 90. Then areas 90a and 91a are determined for use in the template matching. If the second image 91 is disposed higher than the first image 90, areas 90b and 91b are determined for use in the template matching. The various elements of the above embodiments are repeated for basic construction.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image synthesizer comprising:
an overlap area detector for determining an overlap area where at least first and second images are overlapped on one another according to said first and second images;
a feature point detector for extracting feature points from said overlap area in said first image, and for retrieving relevant feature points from said overlap area in said second image in correspondence with said feature points of said first image;
a reducing device for reducing a number of said feature points according to distribution or said number of said feature points;
an image transforming device for determining a geometric transformation parameter according to coordinates of uncancelled feature points of said feature points and said relevant feature points in correspondence therewith for mapping said relevant feature points with said feature points, to transform said second image according to said geometric transformation parameter;
a registration processing device for combining said second image after transformation with said first image to locate said relevant feature points at said feature points.

2. An image synthesizer as defined in claim 1, wherein said reducing device segments said overlap area in said first image into plural partial areas, and cancels one or more of said feature points so as to set a particular count of said feature points in respectively said partial areas equal between said partial areas.

3. An image synthesizer as defined in claim 2, wherein if said particular count of at least one of said partial areas is equal to or less than a threshold, said reducing device is inactive for reduction with respect to said at least one partial area.

4. An image synthesizer as defined in claim 3, wherein said reducing device compares a minimum of said particular count between said partial areas with a predetermined lower limit, and a greater one of said minimum and said lower limit is defined as said threshold.

5. An image synthesizer as defined in claim 2, further comprising a determining device for determining an optical flow between each of said feature points and one of said relevant feature points corresponding thereto.

6. An image synthesizer as defined in claim 5, wherein said reducing device determines an average of said optical flow of said feature points for each of said partial areas, and cancels one of said feature points with priority according to greatness of a difference of an optical flow thereof from said average.

7. An image synthesizer as defined in claim 5, wherein said reducing device selects a reference feature point from said plural feature points for each of said partial areas, and cancels one of said feature points with priority according to nearness of an optical flow thereof to said optical flow of said reference feature point.

8. An image synthesizer as defined in claim 1, wherein said reducing device selects a reference feature point from said plural feature points, cancels one or more of said feature points present within a predetermined distance from said reference feature point, and carries out selection of said reference feature point and cancellation based thereon repeatedly with respect to said overlap area.

9. An image synthesizer as defined in claim 1, further comprising a relative position detector for determining a relative position between said first and second images by analysis thereof before said overlap area detector determines said overlap area .

10. An image synthesizer as defined in claim 1, wherein said image synthesizer is used with a digital camera including first and second camera assemblies for photographing a field of view, respectively to output said first and second images.

11. An image synthesizing method comprising steps of:
determining an overlap area where at least first and second images are overlapped on one another according to said first and second images;
extracting feature points from said overlap area in said first image;
retrieving relevant feature points from said overlap area in said second image in correspondence with said feature points of said first image;
reducing a number of said feature points according to distribution or said number of said feature points;
determining a geometric transformation parameter according to coordinates of uncancelled feature points of said feature points and said relevant feature points in correspondence therewith for mapping said relevant feature points with said feature points, to transform said second image according to said geometric transformation parameter;
combining said second image after transformation with said first image to locate said relevant feature points at said feature points.

12. An image synthesizing method as defined in claim 11, wherein in said reducing step, said overlap area in said first image is segmented into plural partial areas, and one or more of said feature points are canceled so as to set a particular count of said feature points in respectively said partial areas equal between said partial areas.

13. An image synthesizing method as defined in claim 12, wherein if said particular count of at least one of said partial areas is equal to or less than a threshold, said reducing step is inactive for reduction with respect to said at least one partial area.

14. An image synthesizing method as defined in claim 13, wherein in said reducing step, a minimum of said particular count between said partial areas is compared with a predetermined lower limit, and a greater one of said minimum and said lower limit is defined as said threshold.

15. An image synthesizing method as defined in claim 12, further comprising a step of determining an optical flow between each of said feature points and one of said relevant feature points corresponding thereto.

16. An image synthesizing method as defined in claim 15, wherein in said reducing step, an average of said optical flow of said feature points is determined for each of said partial areas, and one of said feature points is canceled with priority according to greatness of a difference of an optical flow thereof from said average.

17. An image synthesizing method as defined in claim 15, wherein in said reducing step, a reference feature point is selected from said plural feature points for each of said partial areas, and one of said feature points is canceled with priority according to nearness of an optical flow thereof to said optical flow of said reference feature point.

18. An image synthesizing method as defined in claim 11, wherein in said reducing step, a reference feature point is selected from said plural feature points, and one or more of said feature points present within a predetermined distance from said reference feature point is canceled, and selection of said reference feature point and cancellation based thereon are carried out repeatedly with respect to said overlap area.
